(19) United States
(12) Patent Application Publication
(10) Pub. No.: US 2018/0322170 A1
(43) Pub. Date: Nov. 8, 2018

(54) EVENT PROCESSING SYSTEM

(71) Applicant: Mediasift Limited, Reading (GB)

(72) Inventors: Lorenzo ALBERTON, Reading (GB); Ashley David JEFFS, Reading (GB)

(21) Appl. No.: 15/588,306

(22) Filed: May 5, 2017

(51) Int. Cl. G06F 17/30; G06F 21/62

(52) U.S. Cl. CPC G06F 17/30516; G06F 21/6254; G06F 17/30867; G06F 17/3048; G06F 17/30321

(57) ABSTRACT

This disclosure relates to the processing of user events. In particular, it addresses various problems relating to the augmentation of a user event—received in a data stream of sequenced events—with data of one or more cooperating reference data items. For example, the augmented user events may be stored in an index on which queries can be run in real-time to extract aggregate and preferably anonymized information from those events according to the queries. Other example use-cases are also disclosed.

### TECHNICAL FIELD

The present invention relates to a system for processing events.

### BACKGROUND

There are various contexts in which it is useful to extract aggregated and anonymized information relating to users of a platform.

For example, understanding what content audiences are publishing and consuming on social media platforms has been a goal for many for a long time. The value of social data is estimated at $1.3 trillion but most of it is untapped. Extracting the relevant information is challenging because of the vast quantity and variety of social media content that exists, and the sheer number of users on popular social media platforms, such as Facebook, Twitter, LinkedIn etc. It is also made even more challenging because preserving the privacy of the social media users is of the utmost importance.

A data platform that is available today under the name DataSift PYLON connects to real-time feeds of social data from various social media platforms (data sources), uncovers insights with sophisticated data augmentation, filtering and classification engine, and provides the data for analysis with an appropriate privacy protocol required by the data sources.

It allows insights to be drawn from posts, shares, re-shares, likes, comments, views, clicks and other social interactions across those social media platforms. A privacy-first approach is adopted to the social media data, whereby (among other things) results are exclusively provided in an aggregate and anonymized form that makes it impossible to identify any of the social media users individually.

In the context of event processing, the need arises in various contexts to analyze user activity on a platform—not only social media platforms where the events correspond to social interactions, but other types of platform with other types of user event relating to activity on different types of platform.

### SUMMARY

The present disclosure addresses various problems relating to the “augmentation” of a user event—received in a data stream of sequenced events (feed)—with data of one or more cooperating reference data items. In this manner, context derived from the reference event is added to the user event. Augmenting user events in this manner allows simpler processing and analysis of the augmented events, as it reduces the extent to which they need to be cross referenced with other data during the analysis. For example, in embodiments of the invention, the augmented user events may be stored in an index on which queries can be run in real-time to extract aggregate and preferably anonymized information from those events according to the queries. To respond to the query, the system determines whether or not each event in the index satisfies at least one query parameter (filter) of the query. By augmenting the events with the information necessary to make this determination, queries can be responded to quickly without having to cross-reference between events stored in the index.

As will be apparent to the skilled person, such augmentation is a form of “data joining”. Various data joining solutions do exist today. For example, “Kafka Streams” is a library component of the Apache Kafka data streaming platform that provides various data joining operations to perform different types of data joins. These allow events to be joined to other stream events (stream-stream joining) or to data items in a table (stream-table joining). (It also allows table items to be joined to other table items—table-table joins). Similar data joining techniques have been explored elsewhere.

There are a few common themes with the existing approaches to data joining:
A) A typical approach would be to simply collect all of the reference data together in a database and query it from the stream in question;
B) Joins across more than two streams aren't supported efficiently; generally the only option here would be to perform joins across the streams are performed two at a time, by cascading the joins.
C) For stream-stream joins, there's an assumption that data from two streams is normally produced about the same time, i.e. as long as the two feeds are kept in sync, the related events should be within a short time window of each other;
D) The stream is usually processed in batches, i.e. the feed is virtually “chopped” into batches of a certain (time window) size, and then the two batches from the two feeds are joined to each other;
E) When joining across feeds, the presence of reference data in the other feed is usually known and guaranteed;

With this in mind, various aspects of the present invention will now be set out.

With regards to A) and B), a first aspect of the present invention is directed to a different approach, whereby multiple joins are essentially performed across more than two data sources to augment a user event with data of multiple reference data items of different types via a series of recursive lookups.

In particular, the first aspect of the invention is directed to a method of augmenting user events, relating to user activity on a platform, with data of reference data items having different reference data types, the method comprising: receiving, at a data processing stage, the user events to be augmented and the reference data items for augmenting the user events, the user events arriving at the data processing stage as a data stream of sequenced events; caching the reference data items in computer storage; and for each of the user events to be augmented, performing an augmentation process for at least one identifier in the user event by: matching a type of the identifier in the user event with a first of the multiple reference data types, and checking whether a matching reference data item of the first reference data type is available in the computer storage by comparing the identifier in the user event with identifiers of the cached reference data item of the first reference data type, and if a match is found: augmenting the user event with data of the matching reference data item of the first reference data type, and repeating the augmentation process for at least one identifier in the matching reference data item of the first reference data type by: matching a type of that identifier with a second of the multiple reference data types, and checking whether a matching reference data item of the second reference data type is available in the computer storage by comparing that identifier with identifiers of the cached reference data items of the second reference data type, and if a match is found: further augmenting the user event with data of the matching reference data item of the second reference data type.

In other words, a recursive lookup on the different types of reference data is performed at the time of lookup, which does require multiple lookups after the user event to be augmented has arrived.

An alternative approach would be to pre-join the reference data items, and store the result, which would then be joined to the user event, in a single step, when it arrives. Such an approach would essentially correspond to A) and B) in the list above, i.e. cascading joins, with the result of the first join being pre-stored for querying at the time of the second join.

However, whilst this alternative approach may seem preferable on the face of it because it permits faster augmentation of the user event (only a single join would be needed when it arrives), the inventors of the present invention have recognized that such an approach becomes impractical in the context of “big data”, i.e. when dealing with very large volumes of data such as those generated by a popular social media platform or data volumes of a similar scale. Practical limitations—relating both to the overall storage requirements and also the limits on how much data can be stored at a single server (node)—mean there comes a point at which the theoretical efficiency gains of pre-joining are dwarfed by practical limitations relating to the storage of the reference data. At this point, the inventors have recognized that performing recursive lookups on multiple (non-joined) reference data items at the time of augmentation becomes a much more viable option, which can lead to significant storage savings vis a vis the cached events and can also simply the partitioning of the cached reference data across multiple nodes.

This recursive lookup approach also makes the system more flexible: it becomes much easier to incorporate new data streams (or other data sources), or remove existing streams “on-the-fly” than in the case of staged joins.

In embodiments, at step 2), the processing stage may be configured to continue checking other content consuming events of the stream of content consuming events whilst the received content consuming is being held in the buffer.

The buffer may comprise a retry queue.

The retry queue may be one of a plurality of retry queues of the event processing system having different retry delays.

The retry queue may be selected for the received content-related event from the plurality of retry queues based on: a type of the received content-related event, or a type of the reference event.

Alternatively or in addition, the retry queue may be selected for the received content-related event from the plurality of retry queues based on: a number of checks that have been performed for that event, or a duration for which checks have been performed for that event.

The data processing stage may be configured to additionally augment at least one of the content-related events with data of a third streamed event from the third data stream cached in the computer storage.

The third event may be located in the computer storage by matching an identifier in the reference event with an identifier in the third event.

The third event may be located in the computer storage by matching an identifier in the content-related event with an identifier in the third event.

The content-related events may be content publication events.

The content-related events may be content consuming events.

The reference events may be content-publication events.

At least some of the reference events may be received in the same data stream as the content-related events.

Alternatively or in addition, the content-related events and at least some of the reference events may be received in separate data streams.

A second aspect of the present invention relates to the problem of building a comprehensive, queryable index of events relating to the publication content or consumption of published content on a publication platform (such as social media) in an event processing system in which the content-related events may arrive out-of-order with respect to cooperating reference events. That is, a later content-related event may be received before an earlier reference event, even though the content-related event represents a later occurrence. For example, the earlier reference event may be a content publication event recording the publication of a piece of content by a publishing user, and the later content-related event may be a content consuming event recording the subsequent consuming of that content by a consuming user. Due to the way events are passed to the system, the content consuming event may arrive first, even though it corresponds to something that has happened at a later point in time. As will be appreciated, this is just one example and there are other situations in which a later content-related event may arrive before an earlier reference event.

The second aspect of the invention provides an event processing system for creating an index of events relating to published content, wherein the events are stored in the index and the index is queryable to extract aggregate information pertaining to the stored events for releasing to a querying device, the event processing system comprising: a processing stage configured to receive content-related events and reference events for the content-related events, the events having identifiers to allow cooperating content-related and reference events to be matched, wherein the events are received in at least one data stream whereby a later content-related event may arrive at the processing stage at a time prior to an earlier cooperating reference event; a buffer for holding content-related events; computer storage for caching reference events for comparison with later content-related events in the buffer; wherein the processing stage is configured to enrich the reference events with metadata, and store in the index the enriched reference events comprising the metadata, wherein a copy of the enriched reference events comprising the metadata is cached in the computer storage; and wherein the processing stage is configured to check for each received content-related event if there is an earlier cooperating reference event in the computer storage, and:
1) if so, augment the received content-related event with a copy of the metadata from the earlier cooperating reference event in the computer storage and store the augmented event in the index, and
2) if not, hold the received content-related event in the buffer and check the computer storage again at a later time to determine if the earlier cooperating reference event has arrived.

With regards to C)-E) in the list above, this approach to handling out-of-order events does not place any particular restrictions on the delay between out-of-order events—as described below in detail, the system is flexible enough to handle delays of hours or even days.

In preferred embodiments of the second aspect, the processing stage is configured to continue checking other content consuming events of the stream of content consuming events whilst the received content consuming is being held in the buffer. That is, the event for which augmentation is unsuccessful is “parked” for a while, whilst the system continues with the next events in the stream. This can significantly disrupt the ordering of the events, but this is of no real concern in the context of building a queryable index for which only aggregate information is released.

Information about the types of the events and/or the expected patterns of arrival can be leveraged to select a suitable retry delay:

In embodiments, the buffer may compose a retry queue, which is preferably one of a plurality of retry queues of the event processing system having different retry delays.

The retry queue may be selected for the received content-related event from the plurality of retry queues based on one of the following factors or any combination thereof:
a type of the received content-related event,
a type of the reference event
a number of checks that have been performed for the content-related event, and
a duration for which checks have been performed for the content-related event.

If no matching reference data item of the first reference data type is found, the user event is held in a buffer and the method comprises checking the computer storage again at a later time to determine if the matching reference data item of the first reference data type has arrived.

If no matching reference data item of the second reference data type is found, the user event augmented with the data of the reference data item of the first type may be held in a buffer and the method may comprise checking the computer storage again at a later time to determine if the matching reference data item of the second reference data type has arrived.

At least one of the user events to be augmented may comprise multiple identifiers, and the augmentation process is performed for each of those identifiers.

The reference data item of the first reference data type may comprise multiple identifiers and the augmentation process may be performed for each of those identifiers.

The augmentation process may be repeated again for at least one identifier in the reference data item of the second reference data type by: determining a type of that identifier as a third of the multiple reference data types, and checking whether a matching reference data item of the third reference data type is available in the computer storage by comparing that identifier with identifiers of the cached reference data items of the third reference data type, and if a match is found: further augmenting the user event with data of the matching reference data item of the third reference data type.

The computer storage may embody multiple reference data stores for the different reference data types and the reference data item are allocated to the reference data stores for caching according to reference data type. The augmentation process may comprise selecting one of the reference data stores by matching the identifier type with the reference data type for that data store, and checking the selected data store for the matching reference data item of that type.

Each of the cached reference data items may be cached in association with an indicator of a type of that reference event.

The augmentation may be performed by generating a modified field, from at least one field in the reference data item, and incorporating the modified field into the user event.

The modified field may be generated by renaming the at least one field.

The computer storage may embody multiple data stores for caching the reference events.

Reference events may be initially cached in both a primary one of the data stores and a secondary one of the reference data stores, and evicted from the primary data store if not accessed within a time limit.

Each of the data stores may be associated with a different compression algorithm used to compress reference events for caching in that data store.

The reference data items may be reference events, each being received in the same data stream as the user events or in a separate data stream of sequenced events. Alternatively, the reference data items may constitute a static data set that is periodically refreshed. Alternatively, the method may be applied to a combination of such reference events and reference data items.

A third aspect of the present invention is directed to an event processing system for augmenting a later user event, relating to user activity on a platform, with data of at least one earlier reference event, the event processing system comprising: a processing stage configured to receive the user event to be augmented and the at least one reference event for augmenting the user event, the events being received as at least one data stream of sequenced events, whereby the later user event may arrive at the data processing stage before the earlier reference event, wherein the events have identifiers to allow the reference event and the user event to be matched; a buffer for holding user events to be augmented; computer storage for caching reference events; wherein the processing stage is configured to check, for the later user event, if the earlier reference event is available in the computer storage, and:
1) if so, augment the later user event with data of the earlier reference event, and
2) if not, hold the later user event in the buffer and check the computer storage again, after expiration of a retry delay, to determine if the earlier reference event has arrived, wherein the retry delay is determined based on at least one of: a type of the user event, a type of the reference event, a number of checks that have already been performed for the user event, and a duration for which checks have been performed for the user event.

This allows out-of-order events to be handled in a more intelligent manner, by tailoring the retry delay to the particular circumstances of a given user event. As will be apparent, there are various ways in which these pieces of information can be leveraged to set a suitable retry delay that reduces or eliminates checks that are unlikely to succeed in the circumstances. Various examples are described below.

In embodiments, the buffer may be one of a plurality of buffers having different retry delays, and the retry delay may be determined for the user event by selecting the buffer for the user event from the plurality of buffers based on the number of checks that have been performed for the user event or the duration for which checks have been performed for the user event.

For example, a longer retry delay may be selected for a greater number of checks or a longer duration of checks.

A fourth aspect of the present invention is directed to an event processing system for augmenting a user event, relating to user activity on a platform, with data of at least one reference event, the event processing system comprising: a processing stage configured to receive the user event to be augmented and the at least one reference event for augmenting the user event, the events being received in at least one data streams of sequenced event, wherein the events have identifiers to allow the reference event and the user event to be matched; and computer storage for caching reference events; wherein the processing stage is configured to check, for the user event, if the earlier reference event is available in the computer storage, and:
1) if so, augment the later user event with data of the earlier reference event and store the augmented event in an index, and
2) if not, determine on a type of the user event to be augmented or a type of the reference event, select one of a set of available failure handling procedure based on the determined event type, and performing the selected failure handling procedure for the user event.

In embodiments, the set of available failure handling procedures may comprise at least two of the following types of failure handling procedure:
a procedure in which the user event is held in a buffer and at least one additional check is performed for the reference event at a later time,
a procedure in which the user event is dropped without any further check for the reference event, whereby the user event is not stored in the index,
a procedure in which the user event is stored in the index without augmenting it with any data of the unavailable reference event.

For the procedure in which the user event is stored in the index without augmenting it with any data of the unavailable reference event, the user event may be partially augmented with data of another reference event and stored in the index.

A first type of user event may not include any user-generated content, and user events of the first type may not be stored in the index if they cannot be augmented with data of the reference event.

A second type of user event may not comprise user-generated content, and user events of the second type may be stored in the index even if they cannot be augmented with data of the reference event.

A fifth aspect of the invention is directed to a method of augmenting user events, relating to user activity on a platform, with data of reference events having different reference data types, the method comprising: receiving, at a data processing stage, the user events and the reference events for augmenting the user events, the events arriving at the data processing stage as multiple data streams of sequenced events; caching the reference events in multiple reference data stores for the different reference data types, wherein the reference events are allocated to the reference data stores for caching according to reference data type; for each of the user events to be augmented: determining a type of at least one identifier in the user event, selecting one of the reference data stores by matching the determined identifier type with the reference data type for that data store, checking whether a matching reference event of the determined reference data type has arrived by comparing the identifier in the user event with identifiers of the reference events in the selected data store, and if a match is found augmenting the user event with data of the matching reference event.

A sixth aspect of the present invention is directed to a computer program product comprising computer readable instructions that are configured, when executed, to carry out any of the method steps of system functionality disclosed herein. The computer readable instructions may be stored on a non-transitory computer readable storage medium. A seventh aspect of the invention is directed to an event processing system comprising at least one processor configured to carry out any of the functionality disclosed herein. An eighth aspect of the invention is directed to a method comprising steps to carry out any of the functionality disclosed herein. Any feature disclosed in relation to any of the above-mentioned aspects of the invention can be implemented in embodiments of any of the other aspects.

For the avoidance of doubt, it is noted that a “user event” can be any event relating to a user with which it is associated. For example, each of the user events may relate to an action performed by or otherwise relating to one of the users of a platform and may comprise an identifier of that user. That is, each of the user events may be a record of a user-related action on the platform. The platform can be any platform with a user base that facilitates user interactions. Whilst this does include social media, the terminology is not limited in this respect and the platform could for example be a platform operated by a telecoms operator like Vodafone or Verizon, a car-hire/ride-share platform like Uber, an online market place like Amazon, a platform for managing medical records etc. The “interactions” can for example be calls, car rides, financial transactions, changes to medical records etc. conducted, performed or arranged via the platform, where the interaction items constitute records of those interactions. In this respect, it is noted that all description pertaining to interaction events of a social media platform (content items) herein applies equally to other types of user events of platforms other than social media.

Note also: references to “events received as at least one data stream of sequences events” (or similar) can mean the events are received in the same data stream, or that they are received in different data streams.

### BRIEF DESCRIPTION OF FIGURES

For a better understanding of the present invention, and to show how embodiments of the same may be carried into effect, reference is made by way of example to the following figures in which:

FIG. 1A shows a schematic block diagram of an index builder of a content processing system;

FIG. 1B shows a schematic block diagram of a real-time filtering and aggregation component of a content processing system;

FIG. 2 shows a schematic block diagram of a computer system in which a content processing system can be implemented;

FIG. 3 shows a block diagram of a content processing system in accordance with the present invention;

FIG. 4 shows a block diagram of a data processing stage;

FIG. 4A shows recursive lookup steps performed as part of an augmentation of an event;

FIG. 4B shows how recursive lookups can be used to perform hierarchical tree-like joins;

FIG. 4C shows an example of an augmented event;

FIG. 4D shows an alternative representation of the recursive lookup of FIG. 4B.

### DETAILED DESCRIPTION OF EMBODIMENTS

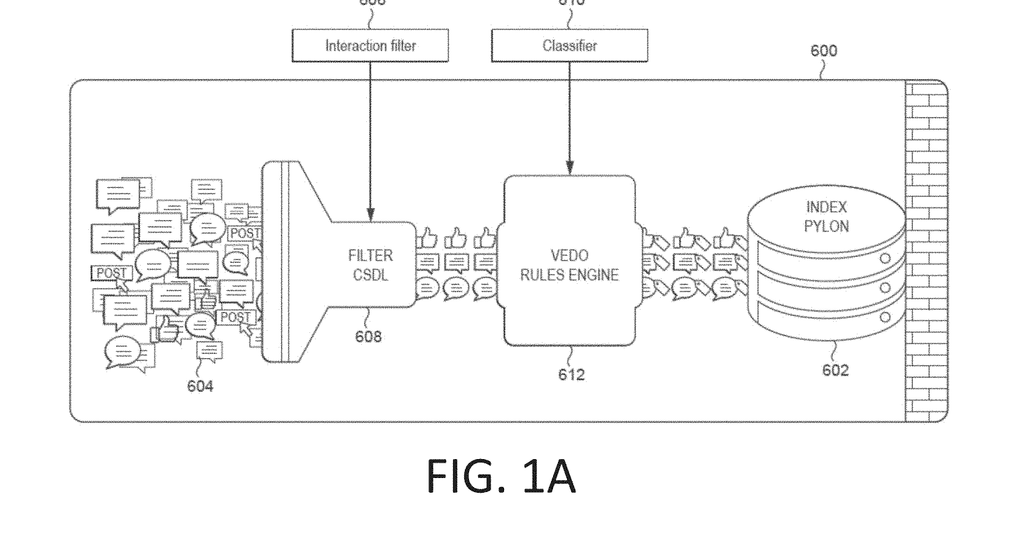

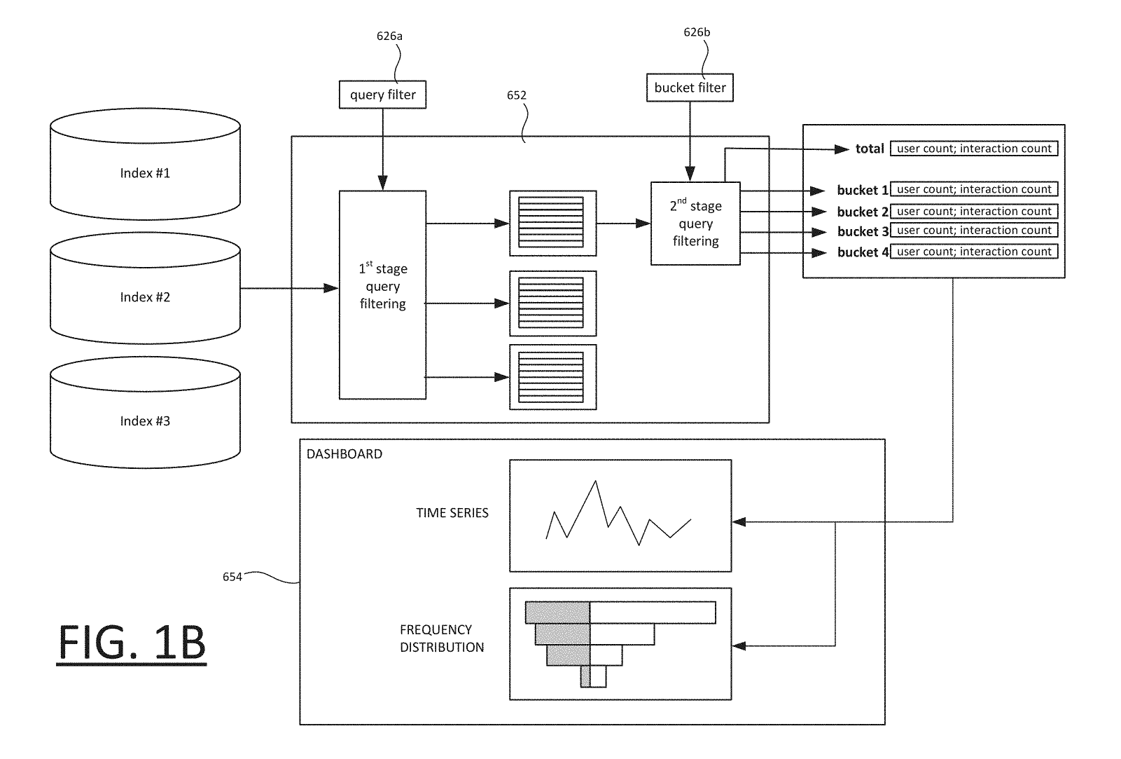

FIG. 1A shows a high level overview of part of a content processing system for processing content items 604 of a social media platform.

Each of the content items 604—also called “interaction events”—is a record of an “interaction” on the social media platform (social interaction), which can be a social media user publishing a new piece of content or consuming an existing piece of content. Examples of different publishing or consuming actions are given later. The events are provided by the social media platform, which is referred to as a “data provider” in this context. They are provided as a real-time data stream or multiple real-time data streams of sequenced events (e.g. different streams for different types of events), also referred to as “firehoses” or “data feeds” herein. That is, the events 604 are received in real-time at an index builder 600 of the content processing system as the corresponding social interactions take place.

Indexes, such as index 602, can be created within the index builder 600. An index is a database in which selectively-made copies of the events 602 are stored for processing. An index can for example be a bespoke database created by a querying user for his own use, i.e. a user of the content processing system who wishes to submit queries to it (such as a customer), or it can be a shared index created by an operator of the content processing system for use by multiple customers. The index 602 holds copies of selected events 604, which are selected by a filtering component 608 of the index builder 600 according to specified filtering rules. These filtering rules are defined in what is referred to herein as an “interaction filter” 606 for the index 602. Viewed in slightly different terms, an index can be seen as a partial copy of a global database (the global database being the set of all events received from the data provider) that is populated by creating copies of the events 604 that match the interaction filter 606.

The index 602 can be created in a “recording” process, which is initialized by providing an interaction filter 606 and which runs from a timing of the initialization to capture events from that point onwards as they occur in real-time. It may also be possible for an index to contain historical events. The interaction filter 608 is applied by the filtering component 608 in order to capture events matching the interaction filter 606, from the firehoses, as those events become available. The process is a real-time process in the sense that it takes as an input the “live” firehoses from the data provider and captures the matching events in real-time as new social interactions occur on the social media platform. The recording process continues to run until the customer 606 (in the case of a bespoke index) or service provider (in the case of a shared index) chooses to suspend it, or it may be suspended automatically in some cases, for example when system limits imposed on the customer are breached.

Each of the events 604 comprises a user identifier of the social media user who has performed the corresponding interaction. As explained in further detail later, by the time the events 604 arrive at the filtering component 608, preferably every one of the events comprises a copy of the content to which it relates; certain “raw” events, i.e. as provided by the data provider, may not include the actual content when first provided, in which case this can be obtained and added in an “augmentation” stage of the content processing system, in which “context building” is performed.

User attributes of the social media users are made available by the data provider from user data of the social media platform, for example from the social media users' social media accounts (in a privacy-sensitive manner—see below). A distinguishing characteristic of such user attributes is that they are self-declared, i.e. the social media users have declared those attributes themselves (in contrast to user attributes that need to be inferred from, say, the content itself). The attributes be provided separately from the raw events representing the publication and consumption of content from the data provider. For example, an attribute firehose may be provided that conveys the creation or modification of social media profiles in real-time. In that case, as part of the context building, the events 604 relating to the publication and consumption of content can be augmented with user attributes from the attribute firehose, such that each of the augmented events 604 comprises a copy of a set of user attributes for the social media user who has performed the interaction.

The idea behind context building is to add context to events that lack it in some respect. For example, a user identifier (ID) in an incoming event may simply be an anonymized token (to preserve user privacy) that has no meaning in isolation; by adding user attributes association. In database terminology, context building can be viewed a form of de-normalization (vertical joining).

Another example is when a data provider provides a separate firehoses of “likes” or other engagements with previous events. In this case, an important function of the augmentation stage is augmenting content consuming events (such as likes, views, clicks, re-shares, comments etc.) with data of a cooperating content publication event, to render the content consuming event meaningful. For example, when a post is liked, augmenting the like event with data of the original post event. That is, augmenting the content consuming event with data of the event representing the earlier publication of the content that has been consumed. This is described in further detail below.

The customer or service provider is not limited to simply setting the parameters of his interaction filter 606; he is also free to set rules by which the filtered events are classified, by a classification component 612 of the index builder 600. That is, the customer/service provider has the option to create a classifier 610 defining classification rules for generating and attaching metadata to the events before they are stored in the index 602. These classification rules can, for example, be default or library rules provided via an API of the content processing system, or they can be rules which the customer or service codes himself for a particular application.

Individual pieces of metadata attached to the events 604 are referred to herein as “tags”. Tags can include for example topic indicators, sentiment indicators (e.g. indicating positive, negative or neutral sentiment towards a certain topic), numerical scores etc., which the customer or service provider is free to define as desired. They could for example be rules based on simple keyword classification (e.g. classifying certain keywords as relating to certain topics or expressing positive sentiment when they appear in a piece of content; or attributing positive scores to certain keywords and negative scores to other keywords and setting a rule to combine the individual scores across a piece of content to give an overall score) or using more advanced machine learning processing, for example natural language recognition to recognize sentiments, intents etc. expressed in natural language or image recognition to recognize certain brands, items etc. in image data of the content. The process of adding metadata tags to events, derived from the content to which they relate, is referred to as “enrichment” below.

In addition to bespoke tags added through enrichment, the events may already have some tags when they are received in the firehoses, for example time stamps indicating timings of the corresponding interactions, geolocation data etc.

With the (additional) tags attached to them in this manner according to the customer's bespoke definitions, the filtered and enriched events are stored in the index 602, populating it over time as more and more events matching the interaction filter 608 are received.

Multiple indexes can be created in this manner, tailored to different applications in whatever manner the service provider/customers desire.

It is important to note that, in the case of private social media data in particular, even when the customer has created the index 602 using his own rules, and it is held in the content processing system on his behalf, he is never permitted direct access to it. Rather, he is only permitted to run controlled queries on the index 602, which return aggregate information, derived from its contents, relating to the publication and/or consumption of content on the content publication platform. The aggregate information released by the content sharing system is anonymized i.e. formulated and released in a way that makes it impossible to identify individual social media users. This is achieved in part in the way the information is compiled based on interaction and unique user counts (see below) and in part by redacting information relating to only a small number of users (e.g. less than one hundred).

Queries are discussed in greater detail below but for now suffice it to say that two fundamental building blocks for the anonymized aggregate information are:
1) interaction counts, and
2) associated unique user counts.

These counts can be generated either for the index 602 as a whole or (in the majority of cases) for a defined subset of the events in the index 602, isolated by performing further filtering of the events held in the index 602 according to “query filters” as they are referred to herein. Taken together, these convey the number of interactions per unique user for the (sub)set of events in question, which is a powerful measure of overall user behaviour for the (sub)set of events in question.

The interaction count is simply the number of events in the index 306 or subset, and the unique user count is the number of unique users across those events. That is, for a query on the whole index 602, the number of events that satisfy (match) the index's interaction filter 606 and the number of unique social media users who collectively performed the corresponding interactions; for a query on a subset of the index 602 defined by a query filter(s), the interaction count is the number of events that also match that query filter(s) (e.g. 606a, 606b, FIG. 1B—see below) and the number of unique social media users who collectively performed the corresponding subset of interactions.

Successive query filters can be applied, for example, to isolate a particular user demographic or a particular set of topics and then breakdown those results into “buckets”. Note, this does not mean successive queries have to be submitted necessarily; a single query can request a breakdown or breakdowns of results, and the layers of filtering needed to provide this breakdown can all be performed in response to that query. For example, results for a demographic defined in terms of gender and country could be broken down as a time series (each bucket being a time interval), or in a frequency distribution according to gender, most popular topics etc. These results can be rendered graphically on user interface, such as a dashboard, in an intuitive manner. This is described in greater detail later.

For example, to aggregate by gender (one of “Male”, “Female”, “Unknown”) and age range (one of “18-25”, “25-35”, “35-45”, “45-55”, “55+”), in the response to an aggregation query (unique user and interaction) counts may be generated for each of the following buckets:

Bucket

Male, 18-25
Male, 25-35
Male, 35-45
Male, 45-55
Male, 55+
Female, 18-25
Female, 25-35
Female, 35-45
. . .
Unknown, 55+

Despite their simplicity, these fundamental building blocks are extremely powerful, particularly when coupled with the user attributes and bespoke metadata tags in the enriched events in the index 602. For example, by generating interaction and user counts for different subsets of events in the index 602, which are isolated by filtering according to different combinations of user attributes and tags, it is possible for an external customer to extract extremely rich information about, say, the specific likes and dislikes of highly targeted user demographics (based on the social interactions exhibited across those demographics) or the most popular topics across the index or subset thereof, without ever having to permit the external customer direct access to the index 602 itself.

For example, a useful concept when it comes to identifying trends within particular user demographics is the concept of “over-indexing”. This is the notion that a particular demographic is exhibiting more interactions of a certain type than average. This is very useful when it comes to isolating behaviour that is actually specific to a particular demographic. For example, it might be that within a demographic, a certain topic is seeing a markedly larger number of interactions per unique user than other topic (suggesting that users are publishing or consuming content relating to that topic more frequently). However, it might simply be that this is a very popular topic, and that other demographics are also seeing similar numbers of interactions per unique user. As such, this conveys nothing specific about the target demographic itself. However, where, say, a topic is over-indexing for a target user demographic, i.e. seeing a greater number of interactions per unique user across the target demographic than the number of interactions per unique user across a wider demographic, then that coveys information that is specific to the target demographic in question.

By way of example, FIG. 1B shows a real-time filtering and aggregation component 652 of the content processing system implementing steps to respond to a query with two stages of filtering to give a breakdown in response to that query.

In the first stage of filtering 654a, a first query filter 626a is applied to the index 602 (shown as one of multiple indexes) to isolate a subset of events 656 that match the first query filter 626a. The first query filter 626a can for example be defined explicitly in the query by the customer, in order to isolate a particular demographic(s) of users of a particular topic(s) (or a combination of both) that is of interest to him.

In the second state of filtering 654b, second query filters 262b (bucket filters) are applied to the subset of events 656. Each of the bucket filters is applied to isolate the events in the subset 656 that satisfy that bucket filter, i.e. the events in a corresponding bucket, so that total interaction and user counts can be computed for that bucket. The total user and interaction counts for each bucket (labelled 656.1-4 for buckets 1-4 in this example) are included, along with total user and interaction counts for the subset of events 656 as a whole, in a set of results 660 returned in response to the query. The results 660 are shown rendered in a graphical form on a user interface, which is a dashboard 654. That is, the result 660 is represented as graphical information displayed on a display to the customer. The underlying set of results 660 can also be provided to the customer, for example in a JSON format, so that he can apply his own processing to them easily.

Multiple subsets can be isolated in this way at the first stage filtering 626a, and each can be broken down into buckets as desired at the second stage 626b.

The buckets can for example be time based, i.e. with each bucket containing events in the subset 656 within a different time interval. These are shown rendered on the dashboard 654 as a graphical time series 655a, with time along the x-axis and the counts or a measure derived from the counts (such as number of interactions per unique user) on the y-axis, which is a convenient and intuitive way of representing the breakdown according to time. As another example, the buckets could be topic based (e.g. to provide a breakdown of the most popular topics in the subset 656) or user based (e.g. to provide a breakdown according to age, gender, location, job function etc.), or a combination of both. In this case, it may be convenient to represent the results as a frequency distribution or histogram 655b, to allow easy comparison between the counts or a measure derived from the counts (e.g. interactions per user) for different buckets. As will be appreciated, these are just examples, and it possible to represent the results for the different buckets in different ways that may be more convenient in some contexts. The information for each bucket can be displayed alongside the equivalent information for the subset 656 as a whole for comparison, for example by displaying on the dashboard 654 the total user and interaction counts or the total number of interactions per unique user across the subset 656 as a whole etc. The dashboard 654 can for example provided as part of a Web interface accessible to the customer via the Internet.

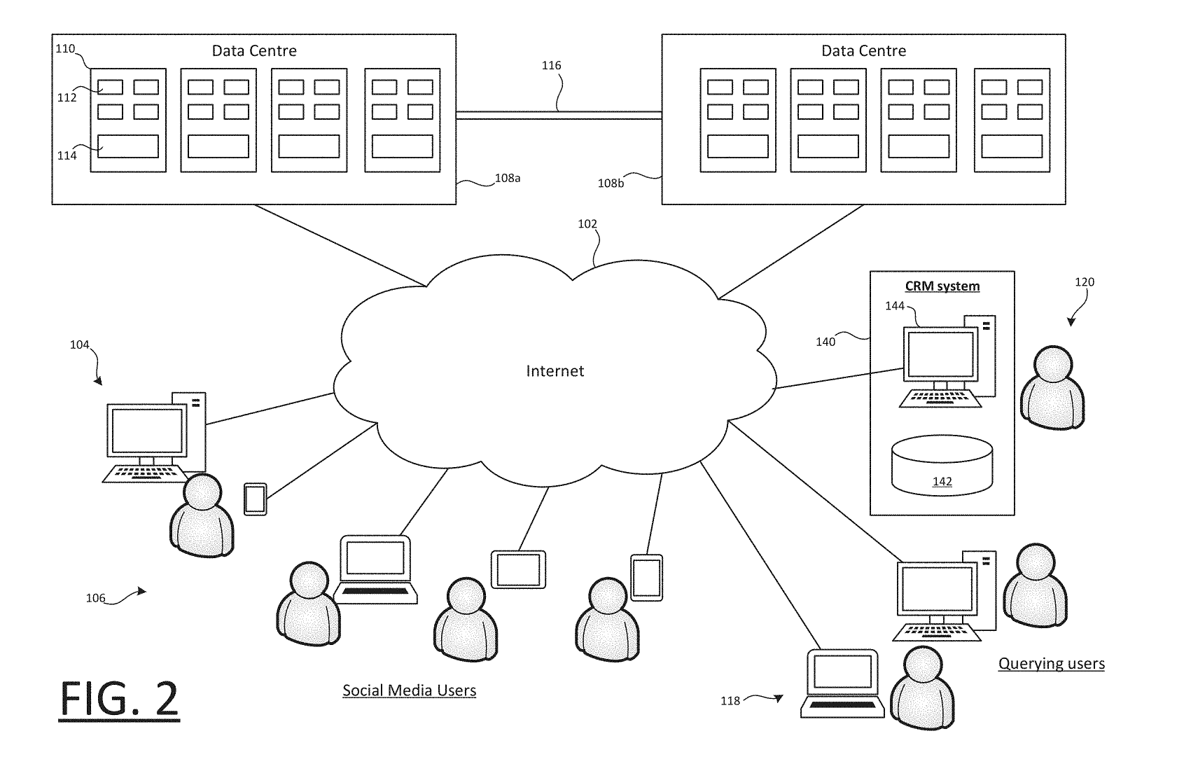

FIG. 2 shows a schematic block diagram of a computer system in which various devices are connected to a computer network 102 such as the Internet. These include user devices 104 connected to the network 102 and which are operated by users 106 of a social media platform.

The term “social media platform” refers herein to a content publication platform, such as a social network, that allows the social media users 106 to interact socially via the social media platform, by publishing content for consumption by other social media users 106, and consume content that other social media users 106 have published. A social media platform can have a very large number of users 106 who are socially interacting in this manner—tens of thousands or more with the largest social media platform today currently having user bases approaching 2 billion users. The published content can have a variety of formats, with text, image and video data being some of the most common forms. A piece of published content can be “public” in the sense that it is accessible to any user 106 of the social media platform (in some cases an account within the social media platform may be needed, and in others it may be accessible to any Web user), or it can be “private” where it is rendered accessible to only a limited subset of the social media users 106, such as the sharing user's friends. That is, private content is rendered accessible to only a limited audience selected by the user publishing it. Friendships and other relationships between the users 106 of the social media platform can be embodied in a social graph of the social media platform, which is a computer-implemented data structure representing those relationships in a computer readable format. Typically, a social media platform can be accessed from a variety of different user devices 104, such as smart phones, tablets and other smart devices, or other general purpose computing devices such as laptop or desktop computers. This can be via a web browser or alternatively a dedicated application (app) for the social media platform in question. Examples of social media platforms included LinkedIn, Facebook, Twitter, Tumblr etc.

Social media users 106 can publish content on the social media platform by generating new content on the platform such as status updates, posts etc., or by publishing links to external content, such as articles etc. They can consume pieces of content published by other social media users 106 for example by liking, re-sharing, commenting on, clicking on or otherwise engaging with that content, or simply having that content displayed to them without actively engaging with it, for example in a news feed etc. (that is, displaying a piece of content to a social media user is considered a consuming act in itself in some contexts, for which an interaction event is created, as it is assumed the user has seen the displayed content). That is, the term “consumption” can cover both active consumption, where it is evident the user has made a deliberate choice to consume a specific piece of content, and passive consumption, where all that is known is that a specific piece of content has been rendered available to a user and it is assumed he has consumed it.

To implement the social media system, a back-end infrastructure in the form of at least one data centre is provided. By way of example FIG. 2 shows first and second data centres 108a, 108b connected to the network 102, however as will be appreciated this is just an example. Large social media systems in particular may be implemented by a large number of data centres geographically distributed throughout the world. Each of the data centres 108a, 108b is shown to comprise a plurality of servers 110. Each of the servers 110 is a physical computing device comprising at least one processing unit 112 (e.g. CPU), and electronic storage 114 (memory) accessible thereto. An individual server 110 can comprise multiple processing units 112; for example around fifty. An individual data centre can contain tens, hundreds or even thousands of such servers 110 in order to provide the very significant processing and memory resources required to handle the large number of social interactions between the social media users 106 via the social media platform. In order to publish new content and consume existing content, the user devices 104 communicate with the data centres 108a, 108b via the network 102. Within each of the data centres 108a, 108b, data can be communicated between different servers 110 via an internal network infrastructure of that datacentre (not shown). Communication between different data centres 108a, 108b, where necessary, can take place via the network 102 or via a dedicated backbone 116 connecting the data centres directly. Those skilled in the art will be familiar with the technology of social media and its possible implementations so further details of this will not be described herein.

The frequent and varied social interactions between a potentially very large number of social media users 106 contains a vast array of information that is valuable in many different contexts. However processing that content to extract information that is meaningful and relevant to a particular query presents various challenges.

The described embodiments of the present invention provide a content processing system which processes events of the kind described above in order to respond to queries from querying users 120 with targeted information relevant to those queries, in the manner outlined above. The querying users 120 operate computer devices 118 at which they can generate such queries and submit them to the content processing system.

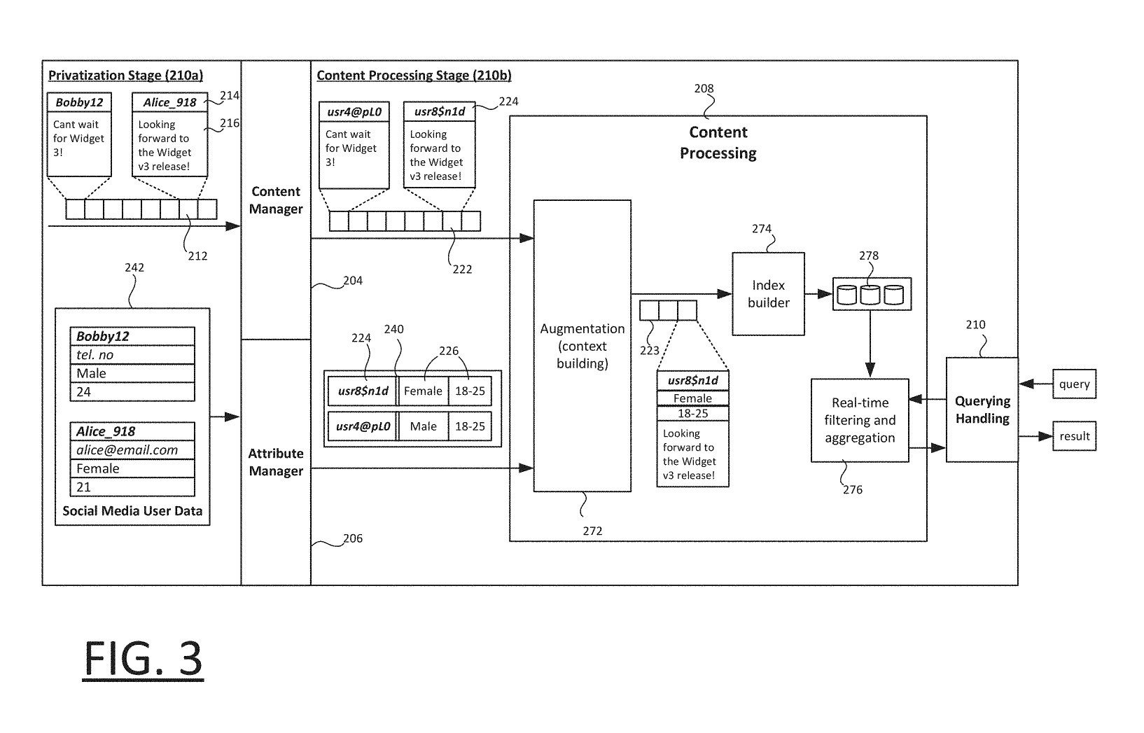

A data processing system 200 comprising the content processing system 202 will now be described with reference to FIG. 3, which a schematic block diagram for the system 300.

The content processing system 202 is shown to comprise a content manager 204, and attribute manager 206, a content processing component 208 and a query handler 210. The content manager 204, attribute manager 206, content processing component 208 and query handler 210 of the content processing system 202 are functional components, representing different high level functions implemented within the content processing system 202.

At the hardware level, the content processing system 202 can be implemented in the data centres 108a, 108b of the social media system back end itself (or in at least one of those data centres). That is, by content processing code modules stored in the electronic storage 114 and executed on the processing units 112. Computer readable instructions of the content processing code modules are fetched from the electronic storage 114 by the processing units 112 for execution on the processing units 112 so as to carry out the functionality of the content processing system 202 described herein. Implementing the content processing system 202 in the social media data centres 108a, 108b themselves is generally more efficient, and also provides a greater level of privacy and security for the social media users 106, as will become apparent in view of the following. However, it is also viable to implement it in a separate data centre (particularly when only public content is being processed) that receives a firehose(s) from the social media platform via the Internet 102.

As explained below, the content manager 204 and attribute manager 206 form part of a privatization stage 210a of the content processing system 202. They co-operate so as to provide an internal layer of privacy for social media users by removing all user-identity from the events and user attributes before they are passed to the content processing component 208. The content processing component 208 and query handler 210 constitute a content processing stage 210b of the content processing system 202, at which events and attributes are processed without ever having access to the users' underlying identities in the social media platform. This privatization is particularly important for private content.

The steps taken to remove the user-identity can be seen as a form of anonymization. However, for the avoidance of doubt, it is noted that removing the user-identity does not fully anonymize the events 212 or user data, as it may still be possible to identify individual users through careful analysis based on their attributes and behaviour. For this reason, the anonymized events and user data are never released by the content processing system 202, and the additional anonymization steps outlined above are taken on top of the removal of the user identity to ensure that individual users can never be identified from the aggregate information released by the system 202.

To implement the privatization, the content manager 204 receives events 212 of the social media platform where, as noted, each of the events 212 represents a social interaction that has occurred on the social media platform and comprises a user identifier 214 of one of the social media users 106 who performed that interaction. That is, the user who published or consumed the piece of content to which the event relates. The user identifiers 214 in the events 212 constitute public identities of the social media users 106. For example, these can be user names, handles or other identifiers that are visible or otherwise accessible to other social media users 106 who can access the published content in question. As part of the privatization stage 210a, the content manager modifies the events 212 to replace the public identifiers 214 with corresponding anonymized user identifiers 224 in the modified events 222, which can for example be randomly generated tokens. Within the content processing stage 210b, the anonymized tokens 224 act as substitutes for the public identifiers 214. The content manager 204 replaces the public identifiers 214 with the anonymous tokens 224 in a consistent fashion, such that there is a one-to-one relationship between the public identifiers 214 and the corresponding tokens 224. However, the public identifiers 214 themselves are not rendered accessible to the content processing stage 210b at any point.

Beyond the fact that these anonymized identifiers 224 allow each user's events to be linked together, these anonymized tokens 224 do not convey any information about the identity of the social media users 106 themselves.

As such, an important function of the attribute manager 206 is one of generating what are referred to herein as “anonymized user descriptions” 240. Each anonymized user description 240 comprises a set of attributes for one of the social media users 106 and is associated with the anonymized user identifier 224 for that user. In the example of FIG. 3B, each of the anonymized user descriptions 240 comprises a copy of the anonymized user identifier 224 and is provided to the content processing component 208 separately from the modified events 222. This in turn allows the content processing component 208 to link individual events 222 with the attributes for the user in question by matching the anonymized tokens in the anonymized user descriptions 240 to those in the events 224, and augmenting those events with those attributes. The user descriptions 240 can be updated as the user attributes change, or as new user information becomes available, for incorporation in subsequent events. Alternatively, the user attributes could instead be provided to the content processing component 208 as part of the events 222 themselves.

The attribute manager 206 can determine the user attributes 226 for the anonymized user descriptions 240 from user data 242 of the social media system itself. For example, the user data that forms part of the social media user's accounts within the social media system. The social media user data 242 can for example comprise basic demographic information such as gender, age etc. From this, the attribute manager 206 can determine basic user attributes such as gender attributes, age (or age range) attributes etc.

User attributes determined from the user data 242 of the social media system itself are referred to herein as a first type of user attribute or, equivalently, “native” attributes (being native to the social media platform itself). The attribute manager 206 may also be able to determine user attributes of other types in certain circumstances, from other sources of data.

The query handler 210 handles incoming queries submitted to the content processing system 202 by the querying users 120. These queries are essentially requests for aggregate information relating to the publication and/or consumption of content within the social media system. As noted, this may involve applying a querying filter(s) where, in general, a querying filter can be defined in terms of any desired combination of user attributes 226 and/or tags. The content processing component 208 filters the events 222 to filter out any events that do not match the querying filter.

The basic elements of a query essentially fall into one of two categories: elements that specify user demographics (in terms of user attributes); and elements that specify particular content (in terms of tags). For the former, the aim is to filter out events 222 for users outside of the desired demographic (filtering by user attribute). For the latter, the aim is to filter out events that are not relevant to the specific tags, (filtering by metadata).

For example, for a query defined in terms of one or more user attributes and one or more tags (see above), the content processing component 208 filters out any events 222 for users without those attributes and any events 222 that do not match those tags, leaving only the events for users having those attributes and which also match those tags. From the filtered events (i.e. the remaining events) the content processing component 208 can extract the desired aggregate and anonymized information.

As will be appreciated, this is a relatively simple example presented for the purposes of illustration and it is of course possible to build more a complex queries and to return results with more detailed information. For example, a general query for any popular topics for a specified demographic of users (as defined by set of attributes) may return as a result one or more popular topics together with a number of unique users in that demographic and who been engaging with that topic. As another example general query requesting information about which demographics a specified topic is popular with may return a set of user attributes and a number of unique users having those attributes and who have engaged with that topic recently. Here, the concept mentioned above of over-indexing becomes pertinent: for example, the response to the query may identify demographics (in terms of attributes) for which the topic is over-indexing, i.e. indicating that this topic is not merely popular within that demographic but more popular than the average across all demographics (or at least a wider demographic).

As noted, certain types of tag, such as topic, can be generated by processing the pieces of published content 216 themselves, for example using natural language processing in the case of text and image recognition in the case of static images or video. This enrichment can be performed before or after the user-identities have been stripped out (or both).

Queries submitted to the content processing system 202 are handled and responded to in real time, where real time in this particular context means that there is only a short delay of two seconds or less between the query being received at the content processing system 202 and the content processing system 202 returning a result. The filtering needed to respond to the query is performed by the content processing component 208 in response to the submission of the query itself. That is, the content processing component 208 performs the filtering in real-time when the query is received. Any pre-processing or enrichment of the events need not be performed in real time, and can for example be performed as the events are received at the relevant part of the system.

Once the events 222 have been filtered as needed to respond to the query in question, the content process component 208 extracts, from the filtered events in real-time, anonymized, aggregate information about social interactions on the social media platform. That is, aggregate information about the publication and/or consumption of content by the social media users 106.

As will be apparent, new events 212 will be constantly generated as the content processing system 202 is in use. For example, for popular social media platforms, hundreds of thousands of new events may be generated every minute as users frequently publish new content or consume existing content. To handle the large volume of data, the resulting anonymized events 222 are only retained at the anonymized content processing stage 210b for a limited interval of time, for example 30 days or so. In that case, the result returned in response to a query relates to activity within the social media platform within that time interval only.

Alternatively, rather than a blanket retention rule of this nature, the amount of time for which events 222 are retained may be dependent on the events themselves. For example events relating to more popular content may be retained for longer. This allows older information for more popular content to be released upon request.

FIG. 3 also shows details of the content processing component 210 in one embodiment of the present invention. The content processing component is shown to comprise an augmentation component 272, which receives the events 222 and the user descriptions 224. These can for example be received in separate firehoses. The augmentation component augments the events 224 with the user attributes 226. That is, for every one of the events 222, the augmentation component adds, to that event 222, a copy of the user attributes associated with the user identifier in that event 222. The augmented events 223 are passed to an index builder 274, which corresponds to the index builder 600 in FIG. 1A and operates as described above to create indexes 278 populated with selected and enriched ones of the augmented events 223. The indexes 278 are rendered accessible to a real-time filtering and aggregation component 276 of the content processing component 210, which operates as described above with reference to FIG. 1B in order to filter and aggregate events in the index in real-time as and when it is instructed to do so by the query handler 210. The indexes 278 and filtering and aggregation component 276 are also shown in FIG. 3A. Events 223 are purged from the indexes 278 in accordance with the retention policy.

As indicated above, whilst the privatization stage 210a is particularly important for private content, it is not essential, and can in particular be omitted for public content in some contexts. In that case, the above techniques can be applied to the original events 212 items directly, using the public identifiers 214 in place of the anonymized identifiers 224.

Augmentation

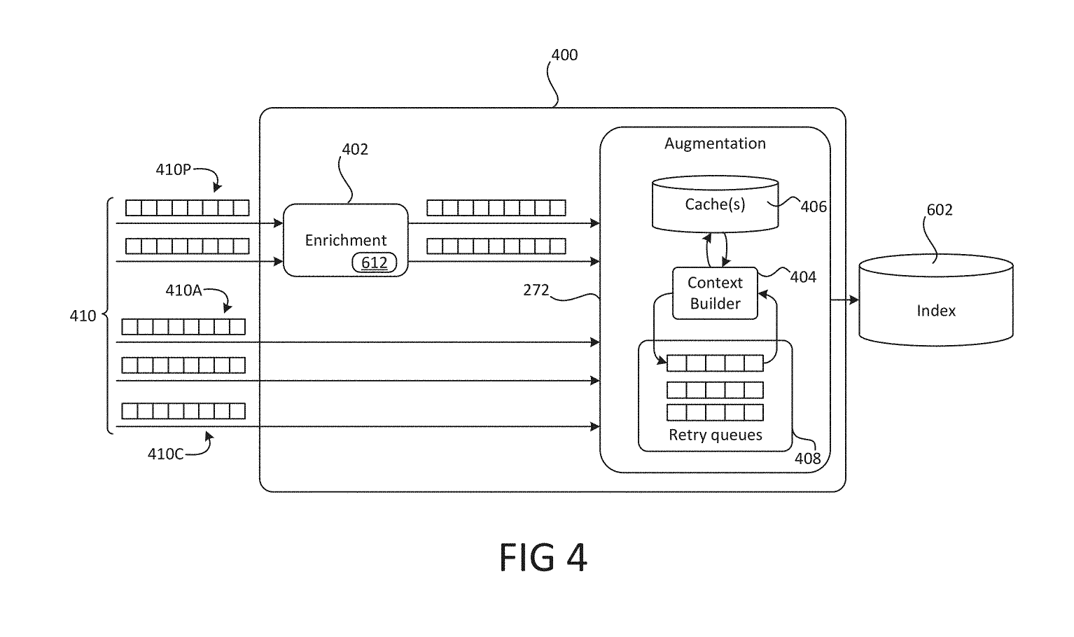

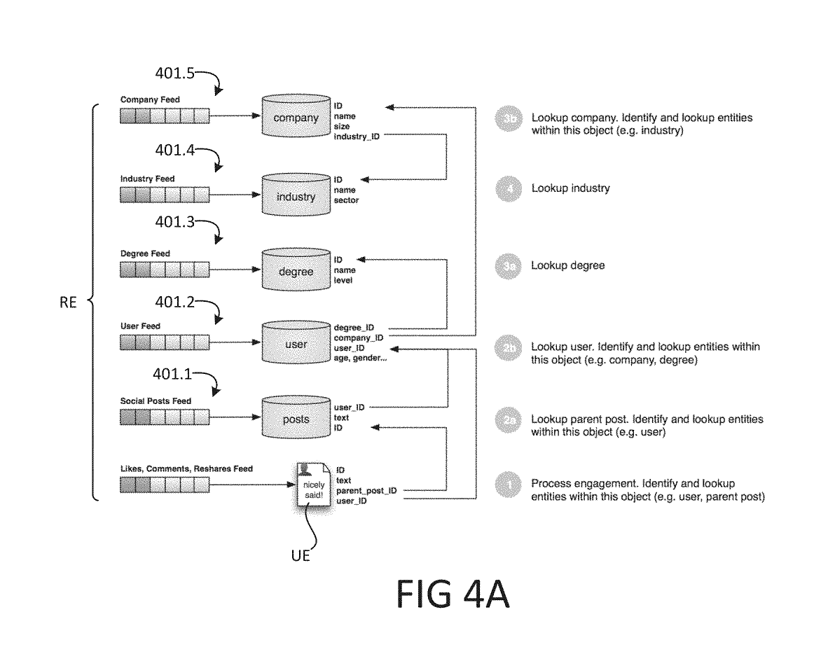

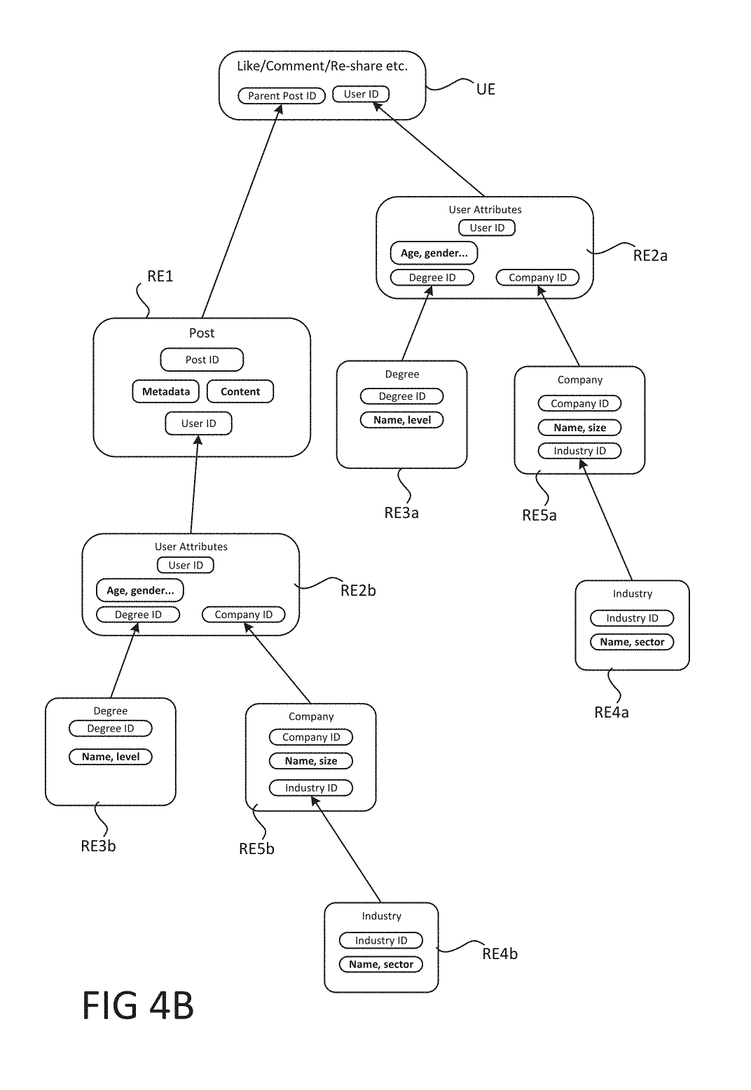

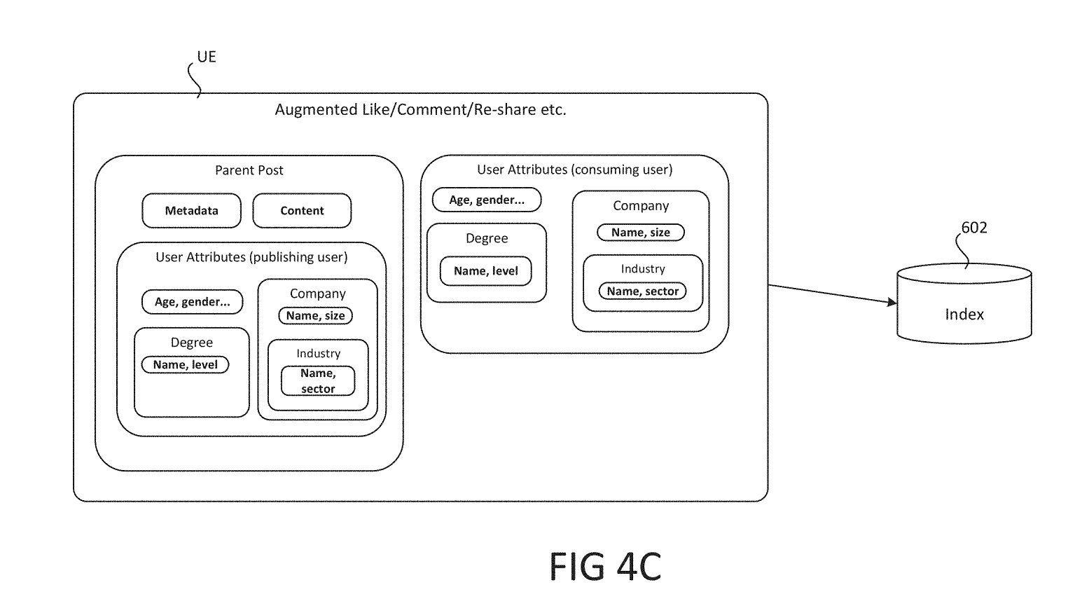

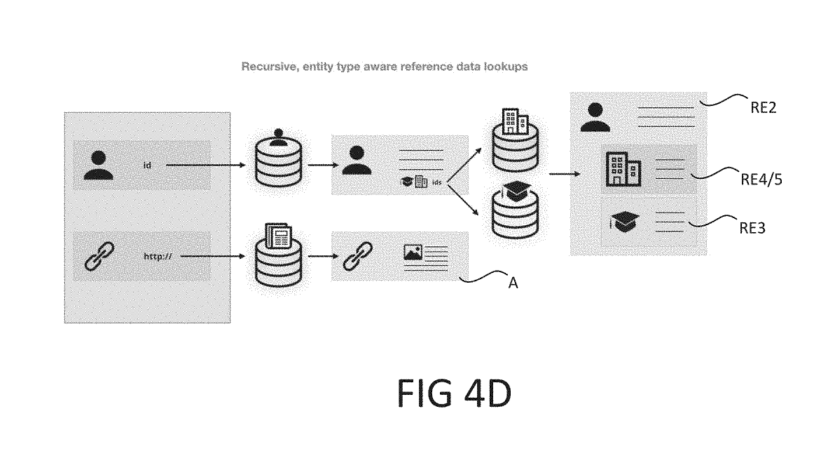

FIG. 4 shows a schematic, high level block diagram of a processing stage 400 of the event processing system which shows further details of the augmentation component 272. The processing stage 400 is shown to comprise an enrichment component 402 comprising the classification component 612 of FIG. 1A, and the augmentation component 272. The augmentation component 272 is shown to comprise a context builder 404 having access to computer storage. The computer storage can be temporary or persistent, or a combination of both. In the following examples it is temporary storage in the form of at least cache 406 and a plurality of buffers, which are retry queues 408; however, the relevant description applies equally to persistent storage. Interaction events, that is both content publication events and content consuming events, are received at the processing stage 400 in multiple firehoses 410 (streams/feeds). In the following examples, it is assumed that each type of interaction event is received in a separate one of the streams 410 specific to that type of event. However, in some cases, events of different types can be received in the same feed—for example, posts and comments may be received in the same feed (see below)—and all of the description herein pertaining to different types of event applies equally to the scenario in which those events are received in the same stream (unless otherwise indicated). The streams 410 are received at the augmentation component 272, however at least one of the streams 410 is enriched by the enrichment component 402 before being passed to the augmentation component 272. In particular, at least one stream of content publication events 410P is enriched by the enrichment component 402 with metadata derived from the published content to which those events relate, though other types of reference event may also be subject to enrichment depending on the context.

For simplicity, this disclosure focuses initially on a specific example use-case, namely augmenting content consuming events 410P (such as likes, views, clicks, re-shares etc.) with data from cooperating content publication events (such as posts). However, as explained below, the system can be applied more generally and other use-cases are considered later.

In this example, at least one of the streams of content consuming events 410C is devoid of context in that the only indication of the content that has been consumed is an identifier of one of the content publication events 410P representing the original publication of that content (cooperating content publication event). Accordingly, a key function of the augmentation component 272 with respect to that stream 410C is to augment the content consuming events therein with data of the cooperating content publication events 410P, and in particular with at least some of the metadata that has been added to those content publication event 410P by the enrichment component 402. That is, to add a copy of that metadata to the appropriate content consuming event 410C such that the augmented events comprise the copy of the metadata. The augmented content consuming events are stored in the index 602 along with the enriched content publication events for querying in the manner described above. That is, both the enriched content publication events 410P comprising the (original) metadata added by the enrichment component 402 and the augmented content publication events 410C comprising the copy of the metadata are stored in the index 602. Although this duplication of data in the index 602 is less efficient in terms of computer storage resources, it allows for faster querying of the index 602 because every event in the index contains the necessary information to determine whether that event satisfies a query filter without having to cross-reference other events in the index 602.

It is important to note that, whilst a content consuming event is necessarily later than the cooperating content publication event (because content can only be consumed after it has been published) there is no guarantee that the content consuming and content publication events will arrive in the “correct” order. That is, a later content consuming event 410C may in fact arrive at the processing stage 400 before the earlier cooperating content publication event. That is, content consuming events and cooperating content publication events may arrive out of order. In this sense, there is no time reference as to the order of the events in the data streams, in that whilst the events may or may not include time stamps for their creation times, time ordering is not imposed strictly on the streams. As explained below, this also applies to other forms of cooperating event which may have complex hierarchical relationships. For the sake of simplicity this disclosure initially focuses on the scenario of out of order content publication events 410P and content consuming events 410C, however it would be appreciated in view of the following that the relevant description applies equally to other cooperating events that may be received out of order.

For example, user attributes may also be received as a stream or streams of sequenced events. For example, a user attribute event may be received each time a set of attributes for a new user becomes available and when one or more of the attributes of an existing user are changed. The content publication events 410P and content consuming events 410C are joined with cooperating user attribute events (410A) containing or indicating the attributes of the publishing or consuming user by the augmentation component 272 in a similar manner, as described in further detail below.

This is another way in which context can be added at the augmentation stage.

The enriched content publication events 410P are stored in the index 602 once they have been enriched. As noted, this is an essentially real time process in which the events are enriched and stored in the index 602 within less than a minute or so of arriving at the processing stage 400. In addition, a copy of the enriched content publication events 410P is cached in the temporary storage 406 as reference data for context-less content consuming events 410C to be augmented. For each of the content consuming events 410C arriving at the processing stage 400, the context builder 404 checks whether the cooperating content publication event 410P is already cached in the temporary computer storage 406. In many cases, it will be, particularly if a relatively large amount of time has elapsed between the original publication of the content by a publishing user and its subsequent consumption by a consumer user. However, in the event that the content has been consumed very soon after its original publication, there is a possibility that the content consuming event 410C will arrive first and that the cooperating content publication event will therefore not yet be available in the temporary computer storage 406 at the time this initial check is performed by the context builder 404. In that event, the content consuming event is placed in one of the retry queues 408, in which it is held for an interval of time (retry delay) after which the context builder 404 checks again to determine whether the cooperating content publication event has arrived and is available in the temporary computer storage 406. If not, the content consuming event 410C is once again returned to the retry queue 408 and this process repeats until such time as the cooperating content publication event becomes available in the temporary computer storage 406 (the process may eventually terminate if a match cannot be made). If and when the content publication event 410P is rendered available in the temporary computer storage 406, the content consuming event 410C is augmented with a copy of the metadata added at the enrichment stage as obtained from the temporary computer storage 406 and the augmented event is stored in the index 602 along with the original enriched content publication event 410P. This augmentation of the content consuming event 410C is a form of “data joining”, whereby the context-less content consuming event 410C is joined with the cooperating content publication event 410P to provide it with the relevant context.

It is noted that this constitutes a high level overview of one aspect of the functionality of the processing stage 400. As described in further detail below, the system is equipped to deal with significantly more complex scenarios than the one outlined above.

Multiple Joins

In this respect, FIG. 4A shows further details of the operation of the data processing stage 400 according to one embodiment of the present invention. The data processing stage 400 is flexible and configurable at runtime.

In particular, FIG. 4A shows how an incoming user event UE (target event) arriving at the data processing stage 400 can be augmented with data from multiple reference data items, which are reference events RE of different reference data types received (in this example) as separate data feeds (404.1-5) at the data processing stage 400. It is also possible for reference events of different types to be received in the same feed as each other and/or in the same feed as the user event UE (see below). The reference events RE are cached at the data processing stage 400 in a manner allows recursive lookups to be performed for the user event UE to be augmented. In other words, multiple joins are performed to join three or more events together (six in this example). In the example of FIG. 4A, the user event UE to be augmented is a content consuming event such as a like, comment or re-share to be augmented with reference data from five different data feeds, namely a social posts feed 401.1 containing the original co-operating content publication event, a user feed 401.2 containing user attributes such as age and gender, a degree feed 401.3 containing information about users' university degrees, an industry feed 401.4 containing information about different industries, and a company feed 401.5 containing information about different companies within those industries. The reference events RE are cached according to reference data type so that a lookup can be performed on reference events for any of the data types.

The user event UE and reference events RE comprise different types of identifier corresponding to different reference data types. That is, identifying other events of different types.

A notable feature of the data processing stage 400 is that the incoming user event UE is augmented with data from the different reference events RE by performing recursive lookups on those reference events RE at the time the user event UE is augmented. That is, all of the multiple joins performed to augment the user event UE are performed only after the incoming user event UE has arrived at the data processing stage 400.

Following the example of FIG. 4A, the incoming user event is shown to comprise, in addition to an identifier of the user event UE and any user-generated content of the user event UE itself (such as text), both a parent post ID of the co-operating post event and a user ID of the content consuming user. That is, the user who has consumed the content as opposed to the user who originally published it (the later rather forms part of the original post event, i.e. content publication event). The content consuming event UE can still comprise user-generated content of its own; for example where it is a record of a comment, the content may be text of the comment that has been left by the consuming user. However, upon arrival of the data processing stage the user event UE does not include any content of the original post being commented on. In order to augment the user event UE with data from the original post event and also with information about the content consuming user, at step 1, the user event UE is processed to identify any entities within the user event corresponding to one of the reference data types on which a lookup can be performed, in this example the user ID and the parent post ID. The parent post ID is used to locate the co-operating publication event as received in feed 401.1 (the “parent post”) which comprises a matching post ID (step 2a). This allows the user event UE to be augmented with data of the matching post event such as the original posted content and the metadata added at enrichment. This is illustrated in FIG. 4B, in which the co-operating post event is labelled RE1.

It is important to note, as illustrated in FIG. 4B, that the user event UE is also augmented with information not only about the user that has consumed the published content, but also the user who originally published that content. In order to obtain the information about the content consuming user, it is first necessary to locate the event in the user feed 401.2 that matches the user ID in the user event UE itself. In order to obtain the information about the publishing user it is the user ID in the original post event RE1, as looked up at step 2a, from the user feed 401.2 that must be located. This is shown as step 2b in FIG. 4B however it is important to note that this actually constitutes two separate lookups that can be performed in parallel: one of which is performed on the user ID in the user event UE itself and the other which is performed on the user ID in the co-operating post event RE1. This is shown in FIG. 4B where the user attribute event for the consuming user is labelled RE2a and the user attribute event for the publishing user is labelled RE2b.

In the present example, for each of those user attribute events RE2a, RE2b further recursive lookups are performed on identifiers within those events to obtain additional information relating to those users.

In particular, a degree identifier in each of the user attribute events RE2a, RE2b is matched to the degree feed 401.3 in order to obtain information about that user's university degree, such as its name and level. This corresponds to step 3a in FIG. 4A, noting that again this actually constitutes two lookups that are performed in parallel for each of the user attribute events RE2a, RE2b. In addition, a company ID in each user attribute event is used to lookup information about the user's company by matching that identifier to a company identifier in one of the company events received in feed 401.5 (step 3b, FIG. 4A) to obtain information about a company associated with that user, such as its name and size. A final lookup is then performed on an industry ID within the located company event (step 4) in order to obtain information about the industry in which the company operates, such as the industry name and sector. Again, this is illustrated in FIG. 4B, in which the degree, company and industry events are labelled as follows: RE3b, RE5b and RE4b for the user attribute event of the publishing user RE2b; and RE3a, RE5a and RE4a respectively for the user attribute event of the content consuming user RE2a.

FIG. 4D shows another schematic illustration of this concept, for a user attribute event RE2, degree event RE3 and industry/company events RE4/RE5. FIG. 4D also shows how web articles A may be cached as reference data items so that they can be used, for example, to augment user event which link to those articles.

As noted, the chain of lookups performed above is triggered in response to the arrival of the user event UE to be augmented at the data processing stage 400 and all of those lookups are thus performed once the user event UE has arrived.

Accordingly, the cached versions of the reference events RE on which the lookups are performed are cached in a non-augmented form in the contemporary computer storage 406. Thus, for example the cached events from the social posts feed 401.1 do not themselves contain information about the post and users but only contain a user identifier that allows this information to be looked up in the events cached from the user attribute feed 401.2. Of course, that is not to say that content post events in feed 401.1 are never augmented with such information. Indeed, when those events are themselves stored in the index 602 (or one of the indexes 602) to enable queries to be run on those events they will indeed be fully augmented and the versions that are stored in the index 602 will be the fully augmented events. However, the versions of the events that are retained in the temporary computer storage 406 as reference data for other events are not augmented in this way.

Although this may increase the number of lookups that need to be performed and result in some duplication of lookup steps, storing the lookups in this way does significantly reduce the storage overhead that is required to cache the reference events. It can also significantly simplify the augmentation process particularly when multiple, hierarchical joins are being performed on events that can be received more or less in any order. The handling of out of order events in this context is described in detail below.

FIG. 4C shows the user event UE once it has been augmented as set out above which is the form in which it is stored in the index 602 for querying. As shown, the augmented user event UE comprises metadata and content from the parent post event RE1. In addition, it also comprises copies of the user attributes both for the content consuming user from the user attribute event RE2a and from the content publishing user from the user attribute event RE2b along with information about both of those user's degrees, companies and the industries of those companies taken from reference events RE3a, RE5a and RE4a and RE3b, RE5b and RE4b respectively. The data in the augmented event can be organised into fields of the event in any desired manner. Where necessary to achieve this, fields of the reference events can be renamed and transformed on the fly as they are mapped to the destination messages. That is, as the joins are performed.

In supporting recursive lookups over different reference data types in this manner, the data processing stage 400 has a number of unique properties. For example, the system supports joins across many (e.g. 10+) feeds at the same time, with no predefined order for the joins.

The system can also effectively perform hierarchical, i.e., a tree-like or graph-like join of multiple entities (identifiers) that appear within each message (event), as in the example of FIG. 4B, where each node in the graph corresponds to an event located by performing a lookup on a higher level node, with the user event UE as the root node.

The joins can be done on properties of inner entities, not just by predefining a “primary key” for each feed. For example, based on the various identifiers in FIGS. 4A/B.

The same entity (e.g. an author object) or type of entity can appear at a different level in the main object that is constructed by the joins. For example, in the graph of FIG. 4A, user attribute events, RE2a, RE2b appear at different levels in the graph for the consuming and publishing users respectively.

The joins can be against entities appearing at any of the above levels (without predetermination).

Note that, although the recursive lookup has been described with reference to online feeds of reference events, the recursive lookup process can also be applied to other types of reference data item. For example, reference data items of a static data set static data, which might get periodically refreshed (e.g. a daily/weekly data dump of all reference data). For the avoidance of any doubt, it is noted that the recursive lookup can be applied to reference events received in an online feed or any other stream of sequenced reference events, but also other types of reference data item such as those in a static dataset (or any combination thereof).

It is also noted different types of reference data feeds or other reference data structure may be quite different in nature: for example, some are static and “complete” (e.g. the data set of all users' properties), whereas others have a more “volatile” nature, such as posts, comments, like etc. whose usefulness in the present context diminishes over time. For the latter, it is generally appropriate to cache them for a certain temporal window, and they automatically expire from the cache, leaving room for new ones, whereas the former may be cached on a more permanent basis.

Out-of-Order Events

Returning to the matter of out-of-order events, although the above assumes each reference event is available at the time of the corresponding look-up. However, in fact there is no strict data ordering requirement for the events in the streams. To handle out-of-order events in an intelligent manner, the data processing stage 400 supports one or more retry queues, with the following properties:
The data processing stage 400 doesn't block data from being processed when it we can't fully resolve the event at the front of the retry queue—it is able to park that one and carry on with the ones behind it.
Multiple retry queues can support different “windows” of visibility in one system (i.e. this approach caters for events that are generated either within a small or a larger time window of each other) thanks to different “retry queues” that are evaluated at different delays (e.g. after 5 minutes, after 1 hour etc.).

Returning to the example of FIG. 4A, if any of the lookups at any of steps 1 to 4 should fail, because the reference event in question has not yet arrived at the data processing stage 400, the system can adopt different behaviours for handling a failure depending on the circumstances in which it is occurred. This is discussed in further detail later, however for the time being this disclosure focuses on one particular failure-handling mechanism using retry queues. In this case, in response to an attempted lookup failing to locate a matching reference event, the user event UE is placed in one of the retry queues 408 and the lookup in question is attempted again at a later time. At the point at which the user event UE is placed in retry queue 408 it may have already been partially augmented with data of one or more reference events which have been successfully located, and the partially augmented user event UE is placed in the retry queue in that event. For example, it might be that a successful lookup has been performed on the user ID step 1 of FIG. 4A to locate the user attribute event for the consuming user RE2a and that the further chain of lookups performed on that use attribute event RE2a have been successfully performed to locate the degree, company and industry information in events RE3a, RE5a and RE4a; however it might be that the parallel lookup of step 1 on the parent post ID has failed because the parent post RE1 has not yet arrived. In that event, the user event UE can still be partially augmented with data from reference events RE2a, RE3a, RE5a and RE4a and the partially-augmented user event UE can be placed in the retry queue. Then, at a later time, the augmentation process can pick up where it left off by attempting the lookup on the parent post ID again and proceeding as described from there if the lookup is successful without having to repeat the lookups that have already been successfully performed.

In terms of the system configuration, the ability of the system to augment for a certain entity type only needs to be defined once, even if the entity type (e.g. a user object) can appear multiple times at different levels in the event to be augmented.

Different retry queues with different retry delays can be selected intelligently by exploiting knowledge of how the reference events are expected to arrive at the data processing stage 400. For example, the inventors of the present invention have recognised certain patterns in the arrival of reference events from large data providers in particular, such as large social media platforms. For the most part, reference events will arrive relatively promptly, that is within a relatively short interval of time relative to the activity on the platform that they represent. Typically, reference events that contain more substantive content, such as longer posts or comments, are delayed a little more than events with less content. It is expected that the reason for this is that the events are subject to processing by the data provider itself before they are provided and that this processing takes somewhat longer for more complex events. This can mean that events do arrive out of order, however for the most part the arrival delays are relatively short. Therefore, for the majority of failed joins, a relatively short retry delay of, say, a few minutes will be sufficient to ensure that the corresponding reference event has arrived by the time a second lookup is performed. However, for a small fraction of reference events, the delay is significantly longer and can be as long as half a day or more. The excessive arrival delays for this handful of “straggler” reference events can for example be caused by a server failure or other system failure at the data provider. It is thus generally the case that reference events are either delayed by at most a short delay or by a significantly longer delay without much in between. Therefore, for the small number of reference events that cannot be located fairly quickly it may make sense to postpone further checks for a much longer interval of time rather than continuously performing quite rapid checks that are unlikely to succeed. In these circumstances, one way of handling out of order reference events that balances processing speed with efficiency is to attempt all of the necessary event lookups for each target event to be augmented when the target event arrives at the data processing stage 400. If any of those lookups fails then the target event is placed in a retry queue with a relatively short retry delay, for example a few minutes such that the failed lookup is attempted again relatively promptly. If the system continues to be unable to locate the reference event, then at some event the reference event is placed instead in a retry queue with a much longer retry delay (e.g. several hours) on the basis that, because the reference event has not arrived by that point it is likely that it will take some time for it to do so if it ever arrives at all.

As will be appreciated, this is just one example of how the predictability of the arrival delays can be used to increase the efficiency of the augmentation without significantly holding up the processing of events.

The system supports per-stream delays, and per-event retry delays. For example by selecting retry queues for events on a per-stream basis based on a type of the stream, or a per-event basis based on a type of the event. Event type in this context can be the type of the user event UE to be augmented, the type of the reference event RE (or both can be taken into account). For example, where information about the expected delay of a certain type of reference event relative to a certain type of user event is known, this information can be leveraged to set a suitable retry delay that allows enough time for the reference event to arrive. This can reduce or eliminate checks that are unlikely to succeed.

It is possible to use different timestamps for delay computation: event time (defined by whatever creates the event), ingestion time (when the event is stored into the feed), and processing time (when the event is processed).

The system is also tolerant to missing reference data for certain entities (the fact that the aim is to provide aggregated data, where a tiny % of failures/errors constitutes an acceptably small error in the aggregate output, and such errors may even be beneficial in terms of preserving user privacy.

Different behaviours can be adopted in case of failure to join an entity i.e. failure to locate one of the reference events (e.g. drop the entire event, or ignore the failure and pass the incomplete event on, or try up to N times (e.g. N=3) and then drop if still failing, etc.). For example, different failure-handling procedures can be selected based on a type of the target event and/or the reference data type of the reference event that cannot be located. For example, content consuming events that contain their own user-generated content (such as a comment) may be retained even if they cannot be augmented as they do have some meaning, whereas consuming events without content (such as likes) may be discarded in that event.

For the scenario in which an incomplete event is passed on for storage in the index 602 when the augmentation is successful, the event may still be partially augmented with data of one or more reference data items that are available. For example, a post event might be augmented with user information, but not with the degree of the user if the latter is unavailable.

Note: as indicated, although in the above the user events UE to be augmented and the reference events with which they are augmented are received in separate feeds, at least some of the reference events may in fact be received in the same feed as the user events. The augmentation of a user event with data of a reference event received in the same stream constitutes an “inner join” on that stream, whereas the augmentation of a user event with data of a reference event from another feed constitutes an “outer join” across streams. For the avoidance of doubt, it is noted that all of the techniques described herein (including but not limited to the recursive lookup and the handling of out of order events) can be applied to both inner joins, outer joins, or a combination of both.

The need for inner joins can arise where two types of events (e.g. posts and comments) are provided via one feed. In that case, events of one type (e.g. posts) are selectively cached as reference events and events of the other type (e.g. comments) are augmented with data from the cached events. The system can be configured to logically treat the two event types differently, even if they arrive via the same feed.

Other Examples of User Events and Reference Data

As noted, all of the techniques described herein can be applied to augment a wide range of user events UE with data of a wide range of reference data items RE. Moreover, depending on the context, certain types of reference events may themselves be augmented for storage in the index 602, but also act as reference events for other events.

Examples of reference data items that may be used to augment events, in the context of social media, include:
1. Articles, for example articles published on the Web and referenced (e.g. linked-to) in posts;
2. Data items containing user attributes (user attribute items), which in general can be streamed reference events or static reference data items in the above sense;
3. University degree, company, industry data items, etc., which again could be streamed or part of static datasets;
4. Content publication events, such as posts, messages etc.;
5. Content consuming events where those events contain content that can be used to augment other events, such as comments, replies etc.;

Examples of user events that might be augmented in the context of social media include:
1. Content publication events, such as posts, messages etc.;
2. Content consuming events of all types, e.g. clicks, views, re-shares, impressions, comments, replies, other engagements etc.

Multiple Caches

The reference events that are cached may be organised into different data stores according to reference data type. That is, different data stores may be used for different types of reference event. Alternatively different types of reference event can be stored in the same data store where type indicators are used to indicate the type of the reference event. This allows the same ID system to be used for different types of reference events, where a unique key that uniquely identifies a reference event is formed of the combination of its type indicator and identifier.

The caching of the reference events RE may be selective, based on certain conditions to be verified (e.g. only cache events with a certain property, like posts made by a company and not by a person).

The system can be configured to support pluggable storage engines for the caches 406: e.g. memcached, mysql, redis, rocksdb, cassandra, etc.

A main store and a fallback store can be nominated for each cache type (e.g. a small, local “hot” cache, and a larger, remote “cold” cache used as a fallback). Events can be stored in both the hot and the cold cache, and the hot cache is configured to evict events no longer actively used, for example those which have not been accessed for a certain amount of time. The two caches are independent and unaware of each other. That is, it is possible to have two stores for the same data set: a large, comprehensive store (usually remote “cold storage”, on sharded nodes, large but slower, which stores all the items in the reference data set, or a large portion of the transient ones), and a hot cache (smaller, faster, usually local—with copies of all items in the hot cache usually also available in the cold storage).

The system can also support different compression algorithms for data in the caches 406.

It will be appreciated that the above embodiments have been described only by way of example. Other variations and applications of the present invention will be apparent to the person skilled in the art in view of the disclosure given herein. The present invention is not limited by the described embodiments, but only by the appendant claims.

1. An event processing system for creating an index of events relating to published content, wherein the events are stored in the index and the index is queryable to extract aggregate information pertaining to the stored events for releasing to a querying device, the event processing system comprising:
a processing stage configured to receive content-related events and reference events for the content-related events, the events having identifiers to allow cooperating content-related and reference events to be matched, wherein the events are received in at least one data stream whereby a later content-related event may arrive at the processing stage at a time prior to an earlier cooperating reference event;
a buffer for holding content-related events;
computer storage for caching reference events for comparison with later content-related events in the buffer;
wherein the processing stage is configured to enrich the reference events with metadata, and store in the index the enriched reference events comprising the metadata, wherein a copy of the enriched reference events comprising the metadata is cached in the computer storage; and
wherein the processing stage is configured to check for each received content-related event if there is an earlier cooperating reference event in the computer storage, and:
1) if so, augment the received content-related event with a copy of the metadata from the earlier cooperating reference event in the computer storage and store the augmented event in the index, and
2) if not, hold the received content-related event in the buffer and check the computer storage again at a later time to determine if the earlier cooperating reference event has arrived.

2. An event processing system according to claim 1, wherein, at step 2), the processing stage is configured to continue checking other content consuming events of the stream of content consuming events whilst the received content consuming is being held in the buffer.

3. An event processing system according to claim 1, wherein the buffer comprises a retry queue.

4. An event processing system according to claim 3, wherein the retry queue is one of a plurality of retry queues of the event processing system having different retry delays.

5. An event processing system according to claim 4, wherein the retry queue is selected for the received content-related event from the plurality of retry queues based on: a type of the received content-related event, or a type of the reference event.

6. An event processing system according to claim 4, wherein the retry queue is selected for the received content-related event from the plurality of retry queues based on: a number of checks that have been performed for that event, or a duration for which checks have been performed for that event.

7. An event processing system according to claim 6, wherein the data processing state is configured to additionally augment at least one of the content-related events with data of a third streamed event from the third data stream cached in the computer storage.

8. An event processing system according to claim 7, wherein the third event is located in the computer storage by matching an identifier in the reference event with an identifier in the third event.

9. An event processing system according to claim 7, wherein the third event is located in the computer storage by matching an identifier in the content-related event with an identifier in the third event.

10. An event processing system according to claim 1, wherein the content-related events are content publication events.

11. An event processing system according to claim 1, wherein the content-related events are content consuming events.

12. An event processing system according to claim 11, wherein the reference events are content-publication events.

13. An event processing system according to claim 1, wherein at least some of the reference events are received in the same data stream as the content-related events.

14. An event processing system according to claim 1, wherein the content-related events and at least some of the reference events are received in separate data streams.

15. A method of augmenting user events, relating to user activity on a platform, with data of reference data items having different reference data types, the method comprising:
receiving, at a data processing stage, the user events to be augmented and the reference data items for augmenting the user events, the user events arriving at the data processing stage as a data stream of sequenced events;
caching the reference data items in computer storage; and
for each of the user events to be augmented, performing an augmentation process for at least one identifier in the user event by:
matching a type of the identifier in the user event with a first of the multiple reference data types, and
checking whether a matching reference data item of the first reference data type is available in the computer storage by comparing the identifier in the user event with identifiers of the cached reference data item of the first reference data type, and if a match is found:
augmenting the user event with data of the matching reference data item of the first reference data type, and
repeating the augmentation process for at least one identifier in the matching reference data item of the first reference data type by: matching a type of that identifier with a second of the multiple reference data types, and checking whether a matching reference data item of the second reference data type is available in the computer storage by comparing that identifier with identifiers of the cached reference data items of the second reference data type, and if a match is found: further augmenting the user event with data of the matching reference data item of the second reference data type.

16. A method according to claim 15, wherein if no matching reference data item of the first reference data type is found, the user event is held in a buffer and the method comprises checking the computer storage again at a later time to determine if the matching reference data item of the first reference data type has arrived.

17. A method according to claim 15, wherein if no matching reference data item of the second reference data type is found, the user event augmented with the data of the reference data item of the first type is held in a buffer and the method comprises checking the computer storage again at a later time to determine if the matching reference data item of the second reference data type has arrived.

18. A method according to claim 15, wherein at least one of the user events to be augmented comprises multiple identifiers, and the augmentation process is performed for each of those identifiers.

19. A method according to claim 15, wherein the reference data item of the first reference data type comprises multiple identifiers and the augmentation process is performed for each of those identifiers.

20. A method according to claim 15, wherein the augmentation process is repeated again for at least one identifier in the reference data item of the second reference data type by: determining a type of that identifier as a third of the multiple reference data types, and checking whether a matching reference data item of the third reference data type is available in the computer storage by comparing that identifier with identifiers of the cached reference data items of the third reference data type, and if a match is found: further augmenting the user event with data of the matching reference data item of the third reference data type.

21. A method according to claim 15, wherein the computer storage embodies multiple reference data stores for the different reference data types and the reference data item are allocated to the reference data stores for caching according to reference data type;
wherein the augmentation process comprises selecting one of the reference data stores by matching the identifier type with the reference data type for that data store, and checking the selected data store for the matching reference data item of that type.

22. A method according to claim 15, wherein each of the cached reference data items is cached in association with an indicator of a type of that reference event.

23. A method according to claim 15, the augmentation is performed by generating a modified field, from at least one field in the reference data item, and incorporating the modified field into the user event.

24. A method according to claim 23, wherein the modified field is generated by renaming the at least one field.

25. A method according to claim 15, wherein the computer storage embodies multiple data stores for caching the reference events.

26. A method according to claim 25, wherein reference events are initially cached in both a primary one of the data stores and a secondary one of the reference data stores, and evicted from the primary data store if not accessed within a time limit.

27. A method according to claim 25, wherein each of the data stores is associated with a different compression algorithm used to compress reference events for caching in that data store.

28. A method according to claim 15, wherein the reference data items are reference events, each being received in the same data stream as the user events or in a separate data stream of sequenced events.

29. A method according to claim 15, wherein the reference data items constitute a static data set that is periodically refreshed.

30. A computer program product for augmenting user events, relating to user activity on a platform, with data of reference data items having different reference data types, the computer program product comprising computer readable instructions stored on a non-transitory computer readable storage medium, the computer readable instructions being configured, when executed, to implement steps of:
receiving, at a data processing stage, the user events to be augmented and the reference data items for augmenting the user events, the user events arriving at the data processing stage as a data stream of sequenced events;
caching the reference data items in computer storage; and
for each of the user events to be augmented, performing an augmentation process for at least one identifier in the user event by:
matching a type of the identifier in the user event with a first of the multiple reference data types, and
checking whether a matching reference data item of the first reference data type is available in the computer storage by comparing the identifier in the user event with identifiers of the cached reference data item of the first reference data type, and if a match is found:
augmenting the user event with data of the matching reference data item of the first reference data type, and
repeating the augmentation process for at least one identifier in the matching reference data item of the first reference data type by: matching a type of that identifier with a second of the multiple reference data types, and checking whether a matching reference data item of the second reference data type is available in the computer storage by comparing that identifier with identifiers of the cached reference data items of the second reference data type, and if a match is found: further augmenting the user event with data of the matching reference data item of the second reference data type.

31-38. (canceled)
